(19) United States
(12) Patent Application Publication
(10) Pub. No.: US 2021/0401672 A1
(43) Pub. Date: Dec. 30, 2021

(54) CHEW TOY FOR DISPENSING MEDICATION

(71) Applicant: Ronaldo Espiritu, Henderson, NV (US)

(72) Inventor: Ronaldo Espiritu, Henderson, NV (US)

(21) Appl. No.: 17/352,838

(22) Filed: Jun. 21, 2021

Related U.S. Application Data
(60) Provisional application No. 63/043,281, filed on Jun. 24, 2020.

(51) Int. Cl. A61J 7/00; A01K 15/02; A61D 7/00

(52) U.S. Cl. CPC A61J 7/0053; A61D 7/00; A01K 15/026

(57) ABSTRACT

A chew toy is provided for dispensing medication to a user, comprising: a) an outer shell comprising an opening; and b) an inner compartment comprising a channel connecting the inner compartment to the opening; wherein the inner compartment comprises means for storing the medication and dispensing the medication through the channel and out of the opening when the user chews the chew toy. In some embodiments, the inner compartment comprises a syringe or a sac. In another embodiment, the inner compartment of the chew toy may comprise a channel that connects a first opening in the chew toy to a second opening connected to an external compartment comprising an external syringe, sac, or any other means for storing and dispensing the medication. Methods of using the chew toys to dispense medication to a user are also provided.

### CROSS-REFERENCE TO RELATED APPLICATIONS

The present invention is related to U.S. Provisional Patent App. No. 63/043,281, entitled “Chewing Toy with Hidden Syringe,” filed on Jun. 24, 2020; the entire disclosure of which is incorporated herein by reference.

### FIELD OF THE INVENTION

The present invention relates to chew toys, particularly chew toys that dispense medication to the user while being chewed on.

### BACKGROUND

The need for medications for humans and their pets has been an ongoing demand throughout history. Medications are used for a variety of reasons, such as to cure a disease or condition, to treat a medical condition, to relieve symptoms of an illness, to prevent diseases, and the like. The most common mode of ingestion for medication is orally, such as in the form of pills, capsules, or liquids.

Often, younger children and pets refuse to ingest medication due to the unwanted and disliked flavor of the medication. The refusal to consume medication can be a problem when the medication is required for the health of the intended recipient. Not receiving the proper amount of medication can be harmful and attempts to administer more to counteract loss of medication during refusal(s) could lead to overdose.

Accordingly, there is a need for improved means for administering medication to younger children or pets.

### SUMMARY

To address the foregoing problems, in whole or in part, and/or other problems that may have been observed by persons skilled in the art, the present disclosure provides compositions and methods as described by way of example as set forth below.

In one embodiment, a chew toy for dispensing medication to a user is provided, comprising:
a) an outer shell comprising an opening; and
b) an inner compartment comprising a channel connecting the inner compartment to the opening;
   wherein the inner compartment comprises means for storing the medication and dispensing the medication through the channel and out of the opening when the user chews the chew toy.

In another embodiment of the chew toy of the invention, the inner compartment comprises a syringe, wherein the syringe comprises a plunger, a body, and a nozzle, wherein the nozzle comprises the channel of the inner compartment and connects the body to the opening; and further wherein when the syringe comprises medication, the chew toy is configured to dispense the medication from the body of the syringe through the nozzle and out of the opening when the user chews the chew toy. The plunger is configured to push the medication out of the syringe through the body and the nozzle, wherein the plunger is located on one end of the syringe, aligns with the body, and is slightly smaller than the body. The body of the syringe is centered within the outer shell, and wherein the nozzle is located on the other end of the syringe opposite the plunger. The nozzle provides a pathway to the opening for the medication to be dispensed to the user, and wherein the nozzle is perpendicular to the body of the syringe.

In another embodiment, the inner compartment comprises a sac and a nozzle connecting the sac to the opening; wherein when the sac comprises medication, the chew toy is configured to dispense the medication from the sac through the nozzle to the opening when the user chews the chew toy. The sac may be any shape, such as a cube, a rectangular solid, a prism, a cylinder, a sphere, a cone, or a pyramid.

In another embodiment, the inner compartment of the chew toy may comprise a channel that connects a first opening in the chew toy to a second opening connected to an external syringe, sac, or any other means for storing and dispensing the medication. The external syringe, sac, or other means for storing and dispensing the medication can be at any angle or position relative to the chew toy and may also be hidden from the user.

In other embodiments, the outer shell of the chew toy comprises a chewable and durable material that is safe for oral administration to be chewed by the user, such as rubber, hard plastic, rope, or hard bark.

In another embodiment, a method is provided for using any of the chew toys described herein to dispense medication to a user, comprising loading the medicine into the inner or external compartments, and providing the chew toy to the user, wherein the user chews the chew toy and the medication is dispensed from the inner or external compartments through a channel in the chew toy and out of an opening in the chew toy. In some embodiments, the user is a pet. In some embodiments, the user is a small child.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 is an isometric view showing the interior of a chew toy in accordance with an embodiment of the invention;

FIG. 2 is a top view showing the interior of the chew toy of FIG. 1;

FIG. 3 is a front view showing the interior of the chew toy of FIG. 1;

FIG. 4 is an isometric view showing the interior of a chew toy in accordance with an embodiment of the invention;

FIG. 5 is a top view showing the interior of the chew toy of FIG. 4;

FIG. 6 is a front view showing the interior of the chew toy of FIG. 4;

FIG. 7 is an isometric perspective view showing the exterior of the chew toy of FIG. 4;

FIG. 8 is a top view of the exterior of the chew toy of FIG. 4;

FIG. 9 is a front view of the exterior of the chew toy of FIG. 4; and

FIG. 10 is a front view of the interior of a chew toy in accordance with an embodiment of the invention.

### DETAILED DESCRIPTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

### Chew Toy for Dispensing Medication

The present invention is directed to a device that is used to ensure the ingestion of medication in humans and pets by concealing the medication within the interior of the device, wherein the exterior of the device is disguised as a chew toy. The present invention dispenses medication to the user while the chew toy is being chewed on. The chew toy may be of any shape or size so long as it contains an inner compartment to conceal the medication.

In one embodiment, a chew toy is provided for dispensing medication to a user, comprising: a) an outer shell comprising an opening; and b) an inner compartment comprising a channel connecting the inner compartment to the opening; wherein the inner compartment comprises means for storing the medication and dispensing the medication through the channel and out of the opening when the user chews the chew toy. The chew toy is configured to dispense the medication from the inner compartment through the channel and out of the opening when the user chews the chew toy. The inner compartment may comprise any means for storing the medication and dispensing the medication through the channel and out of the opening when the user chews the chew toy, including a syringe or a sac.

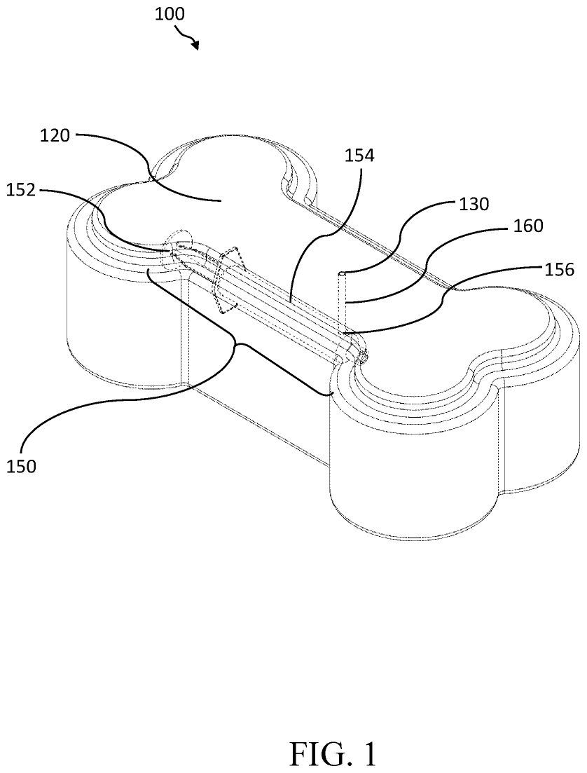

Referring now to FIG. 1, an isometric view is provided showing the interior of a chew toy 100 in accordance with an embodiment of the invention. The chew toy 100 comprises: a) an outer shell 120 comprising an opening 130; and b) a syringe 150 comprising a plunger 152, a body 154, and a nozzle 156, wherein the nozzle 156 connects the body 154 to the opening 130 via a channel 160; and further wherein when the syringe 150 comprises medication, the chew toy 100 is configured to dispense the medication from the body 154 of the syringe 150 through the nozzle 156 into the channel 160 and out of the opening 130 when the user chews the chew toy 100.

The plunger 152 is used to push the medication out of the syringe 150 through the body 154 and the nozzle 156. The plunger 152 is located on one end of the syringe 150 as shown in FIG. 1. The plunger 152 aligns with the body 154 of the syringe and is slightly smaller than the body 154 of the syringe 150 as it penetrates the body 154 and is used to push medication from the body 154, through the nozzle 156, into the channel 160, and out of the opening 130.

The body 154 of the syringe 150 contains and stores the medication that is delivered to the user. The body 154 is centered within the outer shell 120 as shown in FIG. 1. The nozzle 156 is located on the other end of the syringe 150 opposite the plunger 152 as shown in FIG. 1. The nozzle 156 and the channel 160 provide a pathway to the opening 130 for the medication to be dispensed to the user. The nozzle 156 is perpendicular to the body 154 of the syringe 150, unlike standard syringes where a nozzle, needle, or the like is located on one end of the syringe, parallel to the body of the syringe.

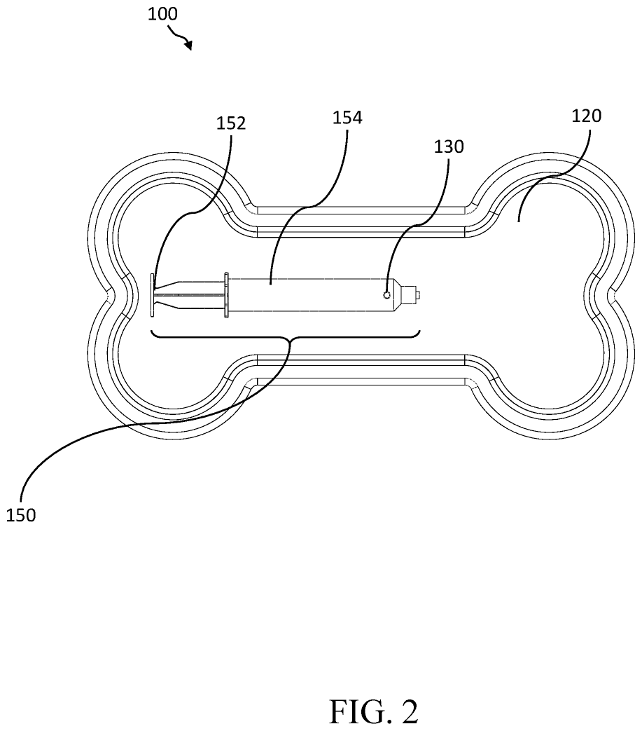

Referring now to FIG. 2, a top view showing the interior of the chew toy 100 of FIG. 1 is provided. Chew toy 100 comprises: a) outer shell 120 comprising opening 130; and b) syringe 150 comprising plunger 152, body 154, and a nozzle (not shown), wherein the nozzle connects body 154 to opening 130 via a channel (not shown); and further wherein when syringe 150 comprises medication, chew toy 100 is configured to dispense the medication from body 154 of syringe 150 through the nozzle into the channel and out of opening 130 when the user chews chew toy 100.

As described above, plunger 152 is used to push the medication out of the syringe 150 through the body 154 and the nozzle. The plunger 152 is located on one end of the syringe 150 as shown in FIG. 2. The plunger 152 aligns with the body 154 of the syringe 150 and is slightly smaller than the body 154 of the syringe 150 as it penetrates the body 154 and is used to push medication from the body 154, through the nozzle 156, into the channel 160, and out of the opening 130.

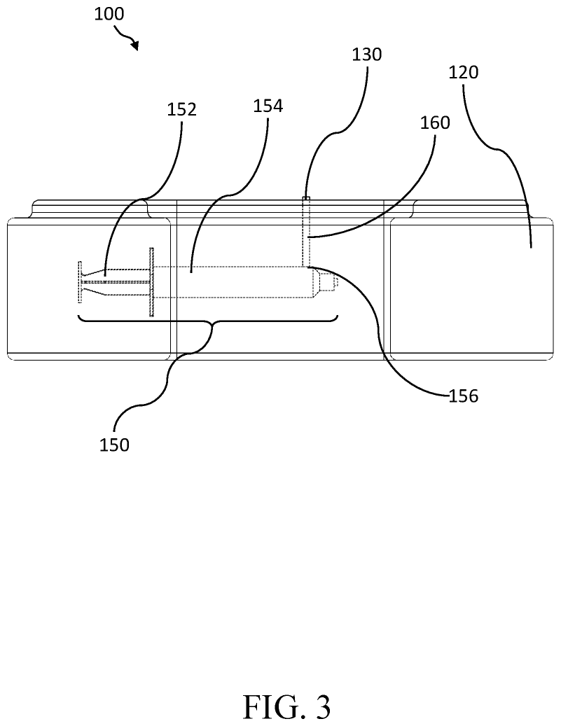

Referring now to FIG. 3, a front view showing the interior of the chew toy of FIG. 1 is provided. Chew toy 100 comprises: a) outer shell 120 comprising opening 130; b) syringe 150 comprising plunger 152, body 154, and nozzle 156, wherein nozzle 156 connects body 154 to opening 130 via channel 160; and further wherein when syringe 150 comprises medication, chew toy 100 is configured to dispense the medication from body 154 of syringe 150 through nozzle 156 into channel 160 and out of opening 130 when the user chews chew toy 100. Plunger 152 is used to push the medication out of syringe 150 through body 154 through nozzle 156 into channel 160 and out of opening 130.

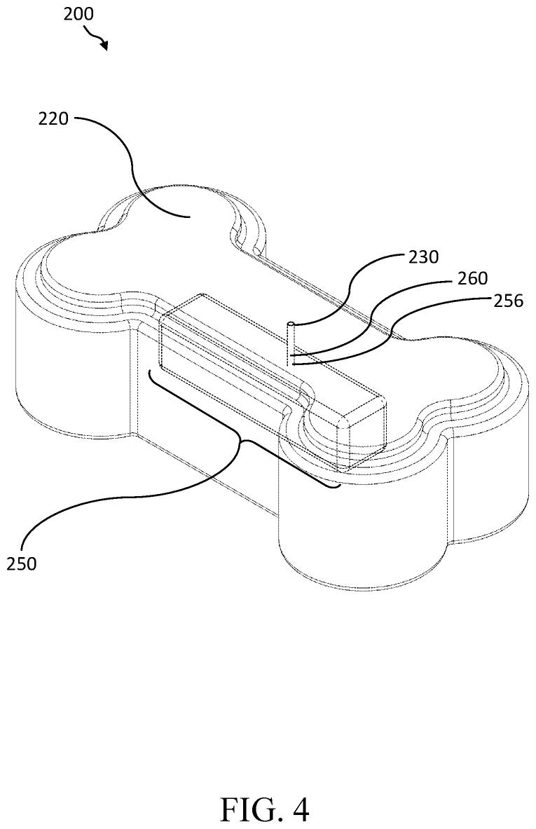

Referring now to FIG. 4, an isometric view is provided showing the interior of a chew toy 200 in accordance with an embodiment of the invention. The chew toy 200 comprises: a) an outer shell 220 comprising an opening 230; b) a sac 250; and c) a nozzle 256 connecting the sac 250 to the opening 230 via a channel 260; wherein when the sac 250 comprises medication, the chew toy 200 is configured to dispense the medication from the sac 250 through the nozzle 256 into the channel 160 and out of the opening 230 when the user chews the chew toy 200.

The sac 250 contains and stores the medication that is delivered to the user. The sac 250 as shown in FIG. 4 is rectangularly shaped (e.g., a cube, a cuboid, and/or a rectangular solid) and is centered within the outer shell 220. However

Nozzle 256 and channel 160 provide a pathway connecting the sac 250 to the opening 230 for the medication to be dispensed to the user.

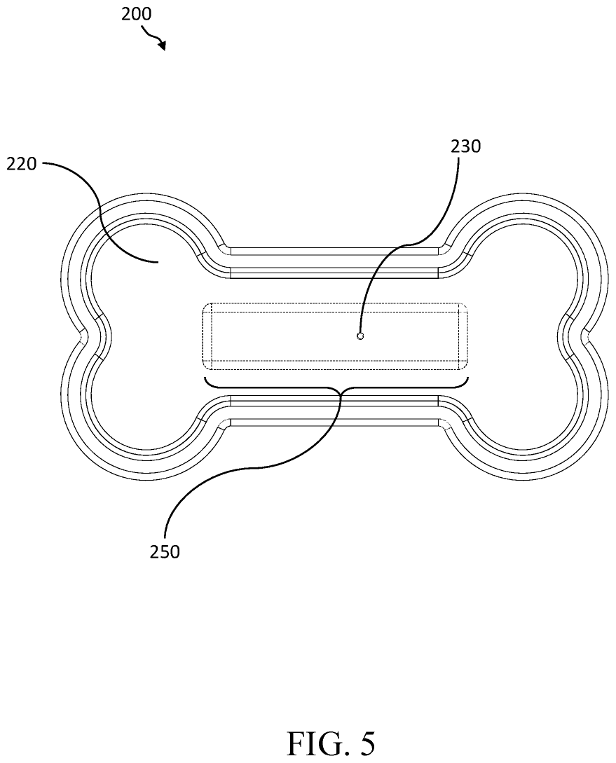

Referring now to FIG. 5, a top view is provided showing the interior of the chew toy 200 of FIG. 4. Chew toy 200 comprises: a) outer shell 220 comprising opening 230; b) sac 250; and c) a nozzle (not shown) connecting sac 250 to opening 230 via a channel (not shown); wherein when sac 250 comprises medication, chew toy 200 is configured to dispense the medication from sac 250 through the nozzle into the channel and out of opening 230 when the user chews the chew toy 200.

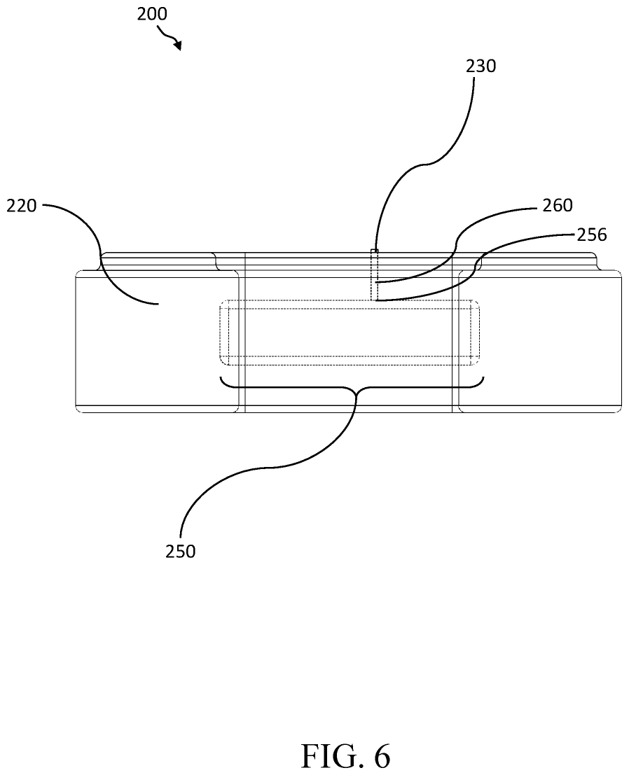

Referring now to FIG. 6, a front view is provided showing the interior of the chew toy 200 of FIG. 4. Chew toy 200 comprises: a) outer shell 220 comprising opening 230; b) sac 250; and c) nozzle 256 connecting sac 250 to opening 230 via channel 260; wherein when sac 250 comprises medication, chew toy 200 is configured to dispense the medication from sac 250 through nozzle 256 into channel 260 and out of opening 230 when the user chews chew toy 200.

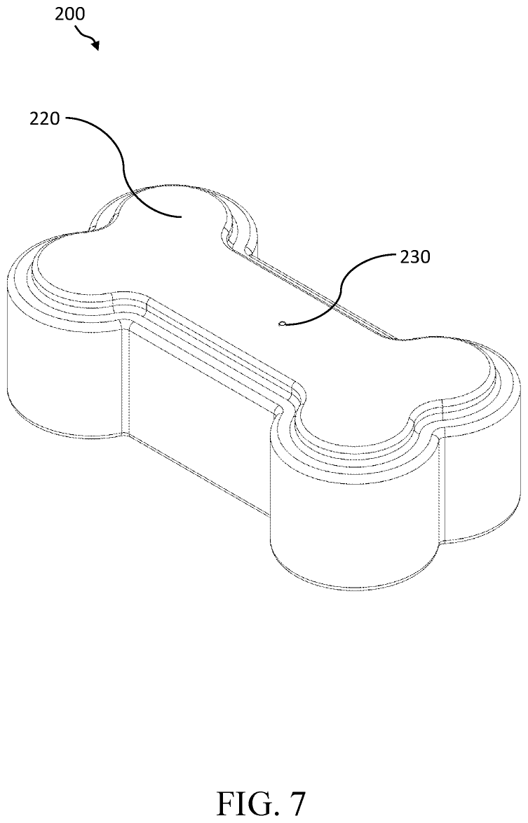

Referring now to FIG. 7, an isometric perspective view is provided showing the exterior of the chew toy 200 of FIG. 4. Chew toy 200 comprises: a) outer shell 220 comprising opening 230; b) a sac (not shown); and c) nozzle (not shown) from the sac to opening 230; wherein when the sac comprises medication, chew toy 200 is configured to dispense the medication from the sac through the nozzle to opening 230 when the user chews the chew toy 200.

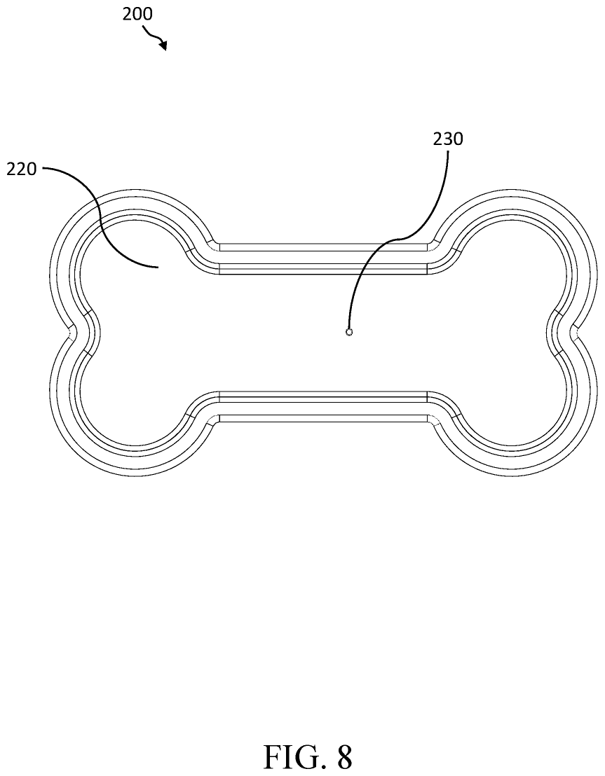

Referring now to FIG. 8, a top view is provided of the chew toy 200 of FIG. 4. Chew toy 200 comprises: a) outer shell 220 comprising opening 230; b) a sac (not shown); and c) nozzle (not shown) from the sac to opening 230; wherein when the sac comprises medication, chew toy 200 is configured to dispense the medication from the sac through the nozzle to opening 230 when the user chews the chew toy 200.

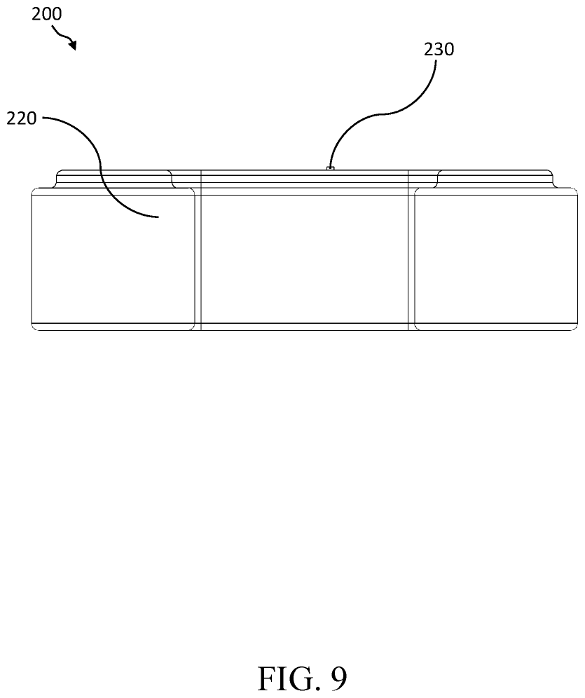

Referring now to FIG. 9, a front view is provided of the chew toy 200 of FIG. 4. Chew toy 200 comprises: a) outer shell 220 comprising opening 230; b) a sac (not shown); and c) nozzle (not shown) from the sac to opening 230; wherein when the sac comprises medication, chew toy 200 is configured to dispense the medication from the sac through the nozzle to opening 230 when the user chews the chew toy 200.

As described above, the outer shell of the chew toy of the present invention is used to conceal medication for dispensing to the user. The user may be a pet or a small child such as a teething baby or toddler.

The outer shell comprises the exterior portion of the chew toy of the present invention and may comprise any shape. For example, FIGS. 1 through 9 show the outer shells of the chew toys in the shape of a bone, but these examples are not intended to limit the scope of the present invention in terms of the shape of the outer shell. The outer shell may be any shape, such as animal shaped, bone shaped, car shaped, fire hydrant shaped, ball shaped, sphere shaped, toroid shaped, cube shaped, rectangular solid shaped, prism shaped, cylinder shaped, cone shaped, pyramid shaped, and the like. The outer shell may be made of any chewable and durable material that is safe for oral administration to be chewed by the user. Exemplary materials that are chewable, durable, and safe for oral administration include, but are not limited to, rubber, hard plastic, rope, hard bark, and the like.

As described above, the inner compartment of the chew toy may comprise any means for storing the medication and dispensing the medication through the channel and out of the opening when the user chews the chew toy. Although FIGS. 1 through 3 show the inner compartment as a syringe and FIGS. 3 through 6 show the inner compartment as a sac, these examples are not intended to limit the scope of the present invention in terms of the shape or configuration of the inner compartment. For example, the inner compartment may comprise any configuration or shape, including a cube, rectangular solid, prism, cylinder, sphere, cone, pyramid, and the like.

The medication that is used with the device may be liquid or solid. Liquid medications are stored in the inner compartment and are delivered sneakily to the user as the chew toy is being chewed. Solid medication such as a pill can be used with the present invention by crushing the solid medication and mixing it with water, thereby transforming the solid medication into a liquid form that can be placed in the inner compartment of the chew toy of the present invention.

In another embodiment, a method is provided for using any of the chew toys described herein to dispense medication to a user, comprising loading the medicine into the inner compartment, and providing the chew toy to the user, wherein the user chews the chew toy and the medication is dispensed from the inner compartment out of the opening. In some embodiments, the user is a pet. In some embodiments, the user is a small child.

In another embodiment, the inner compartment of the chew toy may comprise a channel that connects a first opening in the chew toy to a second opening connected to an external compartment comprising an external syringe, sac, or any other means for storing and dispensing the medication. The external compartment comprising the external syringe, sac, or other means for storing and dispensing the medication can be at any angle or position relative to the chew toy and may also be hidden from the user.

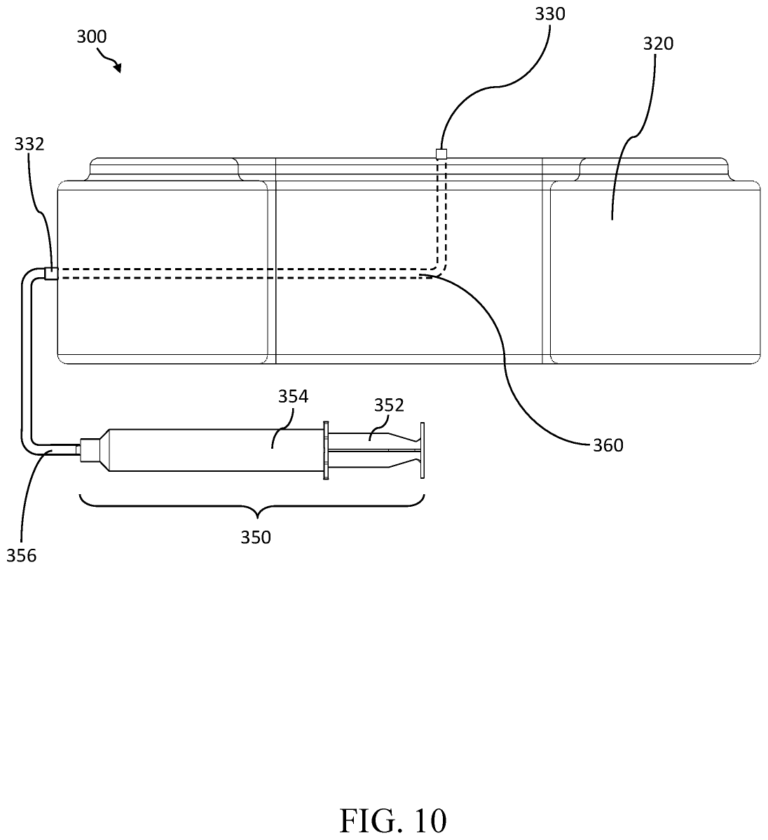

Referring now to FIG. 10, a front view showing the interior of a chew toy 300 is provided. Chew toy 300 comprises: a) an outer shell 320 comprising a first opening 330 and a second opening 332 connected by a channel 360; and b) a syringe 350 comprising a plunger 352, a body 354, and a nozzle 356, wherein the nozzle 356 connects the body 354 to the second opening 332; and further wherein when the syringe 350 comprises medication and the plunger 352 is used to push the medication out of the syringe 350, the chew toy 300 is configured to dispense the medication from the body 354 of the syringe 350 through the nozzle 356 through the second opening 332 into the channel 360 and out of the first opening 330.

The body 354 of the syringe 350 contains and stores the medication that is delivered to the user. The nozzle 356 is located on the other end of the syringe 350 opposite the plunger 352 as shown in FIG. 10. The nozzle 356 connects the body 354 to the second opening 332, and the second opening 332 connects to the first opening 230 by the channel 360, thereby providing a pathway to the first opening 230 for the medication to be dispensed to the user.

In other aspects, the external compartment may comprise a sac and a nozzle connecting the sac to the second opening; wherein when the sac comprises medication, the chew toy is configured to dispense the medication from the sac through the nozzle and the second opening into the channel and out of the first opening. The sac may be any shape, such as a cube, a rectangular solid, a prism, a cylinder, a sphere, a cone, or a pyramid.

In other aspects, a method of using chew toy 300 to dispense medication to a user is provided, comprising loading the medicine into the external compartment, providing the chew toy to the user, and dispensing the medication through the channel and out of the opening when the user chews the chew toy. In some aspects the user is a pet. In other aspects, the user is a small child.

### Definitions

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A chew toy for dispensing medication to a user, comprising:
a) an outer shell comprising an opening; and
b) an inner compartment comprising a channel connecting the inner compartment to the opening;
wherein the inner compartment comprises means for storing the medication and dispensing the medication through the channel and out of the opening when the user chews the chew toy.

2. The chew toy of claim 1, wherein the inner compartment comprises a syringe, wherein the syringe comprises a plunger, a body, and a nozzle, wherein the nozzle comprises the channel of the inner compartment and connects the body to the opening and provides a pathway to the opening for the medication to be dispensed to the user; and
further wherein when the syringe comprises medication, the chew toy is configured to dispense the medication from the body of the syringe through the nozzle and out of the opening when the user chews the chew toy.

3. The chew toy of claim 2, wherein the plunger is configured to push the medication out of the syringe through the body and the nozzle, wherein the plunger is located on one end of the syringe, aligns with the body, and is slightly smaller than the body.

4. The chew toy of claim 3, wherein the body of the syringe is centered within the outer shell, and wherein the nozzle is located on the other end of the syringe opposite the plunger and is perpendicular to the body of the syringe.

5. The chew toy of claim 1, wherein the inner compartment comprises a sac and a nozzle connecting the sac to the opening; wherein when the sac comprises medication, the chew toy is configured to dispense the medication from the sac through the nozzle to the opening when the user chews the chew toy.

6. The chew toy of claim 5, wherein the sac is shaped as a cube, a rectangular solid, a prism, a cylinder, a sphere, a cone, or a pyramid.

7. The chew toy of claim 1, wherein the outer shell comprises a chewable and durable material that is safe for oral administration to be chewed by the user.

8. The chew toy of claim 7, wherein the material is rubber, hard plastic, rope, or hard bark.

9. A method of using the chew toy of claim 1 to dispense medication to a user, comprising loading the medicine into the inner compartment, and providing the chew toy to the user, wherein the user chews the chew toy and the medication is dispensed from the inner compartment out of the opening.

10. The method of claim 9, wherein the user is a pet.

11. The method of claim 9, wherein the user is a small child.

12. A chew toy for dispensing medication to a user, comprising:
a) an outer shell comprising a first opening and a second opening;
b) an inner compartment comprising a channel connecting the first opening and the second opening; and
c) an external compartment comprising means for storing the medication and dispensing the medication through the channel and out of the opening when the user chews the chew toy.

13. The chew toy of claim 12, wherein the means for storing the medication and dispensing the medication comprises an external syringe comprising a plunger, a body, and a nozzle, wherein the nozzle connects the body to the second opening, and wherein when the external syringe comprises medication and the plunger is used to push the medication out of the external syringe, the chew toy is configured to dispense the medication from the body of the external syringe through the nozzle and the second opening into the channel and out of the first opening.

14. The chew toy of claim 12, wherein the external compartment comprises a sac and a nozzle connecting the sac to the second opening; wherein when the sac comprises medication, the chew toy is configured to dispense the medication from the sac through the nozzle and the second opening into the channel and out of the first opening.

15. The chew toy of claim 14, wherein the sac is shaped as a cube, a rectangular solid, a prism, a cylinder, a sphere, a cone, or a pyramid.

16. The chew toy of claim 12, wherein the outer shell comprises a chewable and durable material that is safe for oral administration to be chewed by the user.

17. The chew toy of claim 16, wherein the material is rubber, hard plastic, rope, or hard bark.

18. A method of using the chew toy of claim 12 to dispense medication to a user, comprising loading the medicine into the external compartment, providing the chew toy to the user, and dispensing the medication through the channel and out of the opening when the user chews the chew toy.

19. The method of claim 18, wherein the user is a pet.

20. The method of claim 18, wherein the user is a small child.
